(19) United States
(12) Patent Application Publication
(10) Pub. No.: US 2013/0310142 A1
(43) Pub. Date: Nov. 21, 2013

(54) MECHANICAL SLOT MACHINE REEL HAVING FOUR VIEWABLE FRONT SYMBOL POSITIONS

(71) Applicant: Aristocrat Technologies Australia PTY Limited, North Ryde (AU)

(72) Inventor: Scott Stewart, Las Vegas, NV (US)

(73) Assignee: Aristocrat Technologies Australia PTY Limited, North Ryde (AU)

(21) Appl. No.: 13/889,154

(22) Filed: May 7, 2013

Related U.S. Application Data
(63) Continuation of application No. 12/619,386, filed on Nov. 16, 2009, now abandoned.
(60) Provisional application No. 61/261,157, filed on Nov. 13, 2009.

(51) Int. Cl. G07F 17/34

(52) U.S. Cl. CPC G07F 17/34
USPC 463/20

(57) ABSTRACT

An example gaming machine includes a reel including plurality of symbol positions located around a circumference of the reel. Each symbol occupies a defined viewing angle. The gaming machine includes a motor to drive the reel to spin in a gaming machine housing. The gaming machine includes a controller controlling the motor to stop and start to drive the reel. The gaming machine includes a viewing window providing visual access to the reel through the viewing window, the viewing window configured to allow a user to view at least four symbol positions on the reel through the viewing window so that at least four symbol positions on the reel are active and available for game play.

### CROSS-REFERENCE TO RELATED APPLICATIONS

The present application claims the benefit of priority to U.S. patent application Ser. No. 12/619,386, filed on Nov. 16, 2009, entitled “MECHANICAL SLOT MACHINE REEL HAVING FOUR VIEWABLE FRONT SYMBOL POSITIONS”, which claims the benefit of priority to U.S. Provisional Patent Application No. 61/261,157, filed on Nov. 13, 2009, entitled “MECHANICAL SLOT MACHINE REEL HAVING FOUR VIEWABLE FRONT SYMBOL POSITIONS”, each of which is herein incorporated by reference in its entirety.

### FIELD

The present invention relates to a gaming system, a method of gaming, a game controller, and a computer readable medium storing executable computer program code.

### BACKGROUND

In the casino industry, gaming machines, such as slot machines, fruit machines, or poker machines, have in recent years become one of the more popular, exciting, and sophisticated wagering activities available at casinos and other gambling locations. At the same time, gaming machines have also become a source of greater revenue for gaming establishments.

Gaming machines with rotating reels have been popular for many years. Initially, the rotating reels were mechanical spinning reels housed inside the machine which were spun and randomly stopped to place images on the reels in alignment to determine payouts. Drive mechanisms for the reels have developed substantially overtime to the point where the rotation and, in particular, the stopped position of the reels is precisely controlled, and in turn, manages the allocation of payouts. More recently, electronic gaming machines have been used to simulate spinning reels using computer generated graphics and electronics. However notwithstanding the existence of electronic gaming machines, players are still attracted to, and enjoy, gaming machines having mechanical reels.

A gaming system such as a video slot machine can include symbols displayed as a plurality of virtual reels on a video display. Each reel comprises a plurality of symbols arranged in a predetermined sequence. Typically, when a reel stops, a plurality of symbols of each reel are visible on the display. For example, three symbols of each reel. While the stopping position of the reel can be chosen in a number of different ways, in all cases, the symbols which stop in the display are adjoining symbols in the symbol sequence. Typically, when spinning of the reels is simulated, symbols before the stopped symbols in the symbol sequence will be visible at least as the reel comes to a stop.

### SUMMARY

Certain examples provide methods, systems, and apparatus for gaming and gaming controllers.

Certain examples provide a gaming machine including a reel including plurality of symbol positions located around a circumference of the reel. Each symbol occupies a defined viewing angle. The gaming machine includes a motor to drive the reel to spin in a gaming machine housing. The gaming machine includes a controller controlling the motor to stop and start to drive the reel. The gaming machine includes a viewing window providing visual access to the reel through the viewing window, the viewing window configured to allow a user to view at least four symbol positions on the reel through the viewing window so that at least four symbol positions on the reel are active and available for game play.

Certain examples provide an article of manufacture to be used in a slot machine game. The article of manufacture includes a reel comprising a plurality of symbol positions located around a circumference of the reel. Each symbol occupies a defined viewing angle. A viewing window provides visual access to the reel through the viewing window. The viewing window is configured to allow a user to view at least four symbol positions on the reel through the viewing window so that at least four symbol positions on the reel are active and available for game play.

Certain examples provide a gaming apparatus including a plurality of reels. Each of the plurality of reels includes a plurality of symbol positions located around a circumference of the reel. Each symbol occupies a defined viewing angle. The gaming apparatus includes a plurality of motors. Each motor is to drive one of the plurality of reels to spin in a gaming machine housing. The gaming apparatus includes a controller to control the motors to stop and start to drive the reels. The gaming apparatus includes a viewing window to provide visual access to the plurality of reels through the viewing window. The viewing window is configured to allow a user to view at least four symbol positions on each of the plurality of reels through the viewing window so that at least four symbol positions on each of the plurality of reels are active and available for game play.

### BRIEF DESCRIPTION OF THE DRAWINGS

FIG. 1 is a block diagram of the core components of a gaming system.

FIG. 2 is a perspective view of a gaming machine.

FIG. 3 is a block diagram of the functional components of a gaming machine.

FIG. 4 is a block diagram representing the structure of a memory.

FIG. 5 is a diagram schematic of a networked gaming system.

FIG. 6 is a further block diagram of the gaming system.

FIG. 7 depicts an example electromechanical stepper gaming machine.

FIG. 8 shows a logical representation of a gaming system.

FIGS. 9A-9B illustrate example reel display window implementations.

FIGS. 10A-10B illustrate example reel window implementations.

FIG. 11 illustrates an example reel display window implementation to highlight the 4×5 reel and symbol display and provide indications of eligible symbol positions to players.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, etc. storing the software and/or firmware.

Certain examples are described in detail with reference to gaming machine and/or other display devices incorporating rotating reels. However, it will be appreciated that the display devices and gaming machines described can incorporate many other features in addition to those mentioned in the following description including, for example, video display units, spinning wheels and any other interactive medium which may or may not be played in combination with a game being played on the rotating reels. Although not shown in the drawings, in some examples, the reels are driven by a stepper motor that allows the reels to be moved through a series of incremental positions and, in particular, known stop positions. Operation of the stepper motor is control using one or more suitable computer processors that determine the sequence and position of the images in the reels when in the stop position and, therefore, outcomes of a game. In some examples, electromechanical reels can operate in conjunction with a video/graphical overlay, such as a transparent and/or transmissive overlay, to display multimedia content apart from and/or in conjunction with the reels in the gaming machine.

Traditional three-reel slot machines have one pay line extending across the center of the reels, and the reel window is tall enough to see part of the symbol above and below the pay line. More advanced games use the three forward-facing symbols to allow for three or five lines of display, and some even now use nine lines but could technically go up to twenty-seven (27) unique pay lines. Five-reel slot machines typically have up to 20 or 25 lines, but going beyond 27 is difficult because the first three reels only have 27 unique combinations, which leads to many line shapes overlapping and results in duplicate pays.

The overlapping and duplicate pays has partially been overcome using Reel Power™, where all three of the positions can be used on all five reels for up to 243 unique combinations. However, many players prefer line games to reel games, so five-reel video slot machines have begun displaying four positions on each reel to allow for up to 1024 unique combinations on the first three reels.

Mechanical slot machines have always been limited to three positions on each reel. The limitation may be due to the perception that curvature of the reel drum would make more than three positions difficult for a user to see. However, as discussed herein, careful and innovative design allows for clear game display to the player beyond a three position display in an electromechanical reel gaming system. Certain examples provide increased complexity in mechanical slot machine games and their displays to match complexity on video slot machines. By providing additional rows displayed on an electromechanical machine (e.g., Aristocrat's RFX™ Stepper machines), this also allows for more complex bet structures and higher basic bets.

By having four positions on each reel visible to a user, more complex games are possible, such as 50 or more lines, or Super Reel Power™ models with 4096 combinations. Mechanical slot machines have always been limited to three displayed reel positions and the game types which that allows.

In a first form, a stand alone gaming machine is provided wherein all or most components to implement a game are present in a player operable gaming machine.

In a second form, a distributed architecture is provided wherein some of the components to implement a game are present in a player operable gaming machine and some of the components to implement the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisioned. For example, an architecture may be provided wherein a gaming machine is networked with a gaming server and the respective functions of the gaming machine and the gaming server are selectively modifiable. For example, the gaming system may operate in stand alone gaming machine mode, “thick client” mode, or “thin client” mode depending on the game being played, operating conditions, etc. Other variations will be apparent to persons skilled in the art. The architecture can work in conjunction with an electromechanical gaming machine to provide control for the reels as well as graphical and/or other multimedia content with respect to the reels and/or display portions of the machine gaming cabinet.

A gaming system can be any gaming machine such as a slot machine, fruit machine, video Poker machine, Keno or Bingo machine, or any other electromechanical stepper machine. A gaming system may also include a multi-terminal gaming machine that may be interfaced with a player tracking module and slot accounting system. Thus, a gaming system is not limited to any specific kind of gaming device.

A gaming system can provide primary or main game(s) and secondary or bonus/feature games to a player. Games can be provided via preconfigured storage at the gaming system, via download from an external source, and/or via server-based execution, for example. Games can be provided in response to certain player and/or casino actions, including but not limited to player tracking rewards, game play, casino promotions, tournament play, etc. Gaming systems can provide player and/or game play data to a management system and/or external monitor for player tracking, auditing, slot accounting, regulatory/licensing compliance, and/or other purpose, for example.

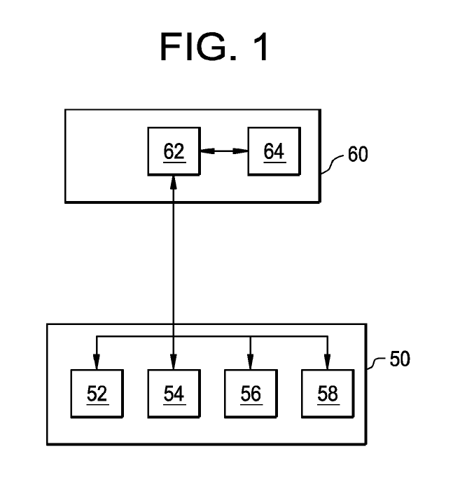

Irrespective of the form, the gaming system includes several core components. At the broadest level, the core components are a player interface 50 and a game controller 60 as illustrated in FIG. 1. The player interface 50 is arranged to enable manual interaction between a player and the gaming system and for this purpose includes the input/output components for the player to enter instructions and play the game.

Components of the player interface 50 may vary from embodiment to embodiment but will typically include a credit mechanism 52 to enable a player to input credits and receive payouts, one or more displays 54, a game play mechanism 56 that enables a player to input game play instructions, and a speaker 58.

The game controller 60 is in data communication with the player interface and typically includes a processor 62 that processes the game play instructions in accordance with game play rules and outputs game play outcomes to the display(s) 54. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g., a personal computer) or a server. The processor 62 can be used to drive and control mechanical reels and/or provide content for display via a screen, for example.

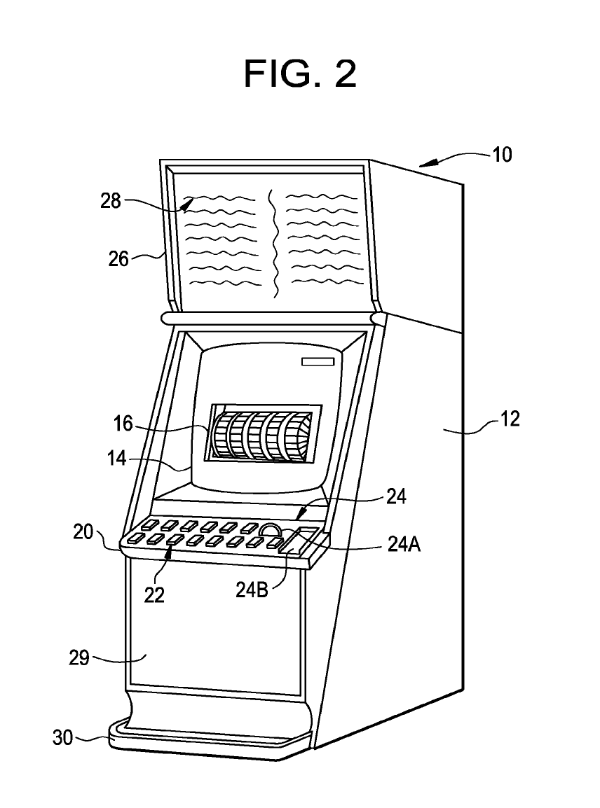

A gaming system in the form of a stand alone gaming machine 10 is illustrated in FIG. 2. The gaming machine 10 includes a console 12 having a display 14 through which a plurality of electromechanical reels 16 are displayed for play by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill/voucher acceptor 24B. Other credit input mechanisms may also be employed, for example, a card reader for reading a smart card, debit card or credit card. A player tracking module can be provided having a reading device for the purpose of reading a player tracking device, for example as part of a loyalty program. The player tracking device can be in the form of a card with a machine readable element such as a magnetic stripe, flash drive, and/or any other portable storage medium capable of being read by the reading device, for example.

A top box 26 can carry artwork 28, including, for example, pay tables and details of bonus awards and other information and/or images relating to the game. The top box 26 can include a display, for example, a video display unit, such as a cathode ray tube (CRT) screen device, a liquid crystal display (LCD), plasma screen, and/or any other suitable video display unit. Further artwork and/or information may be provided on a front panel 29 of the console 12. A coin tray 30 is mounted beneath the front panel 29 for dispensing cash payouts from the gaming machine 10.

The display 14 may include a game display area including the reels and a surrounding border or background, for example. Where a transmissive display is used, the transmissive display may overlay all or part of the game display area on the display 14. Video displays (e.g., LCD, CRT, plasma, etc.) and/or other illuminating or light sources (e.g., lamps, light emitting diodes (LEDs), etc.) may also be integrated with spinning reels to illuminate or animate desired display locations such as pay lines, pay combinations, winning lines, winning combinations, special symbols, etc.

Lighting may also be used to backlight symbols and/or generating a flickering or flashing effect as the electro-mechanical reels spin, for example. In certain embodiments, one or more light sources may be used with one or more filters to adjust certain characteristics of light emitted by the one or more light sources (e.g., altering lamp light to simulate natural daylight), for example.

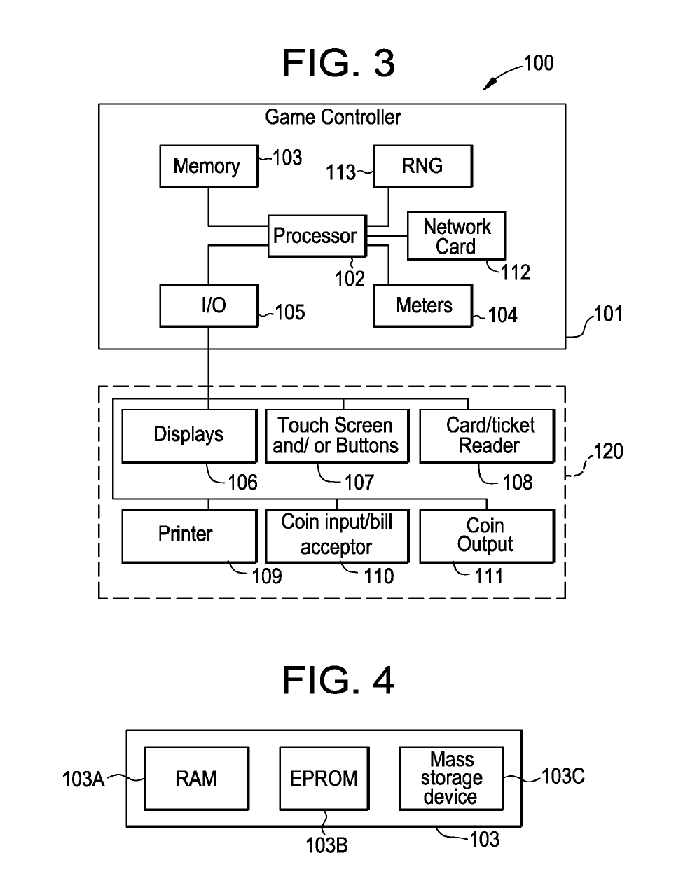

FIG. 3 shows a block diagram of operative components of a typical gaming machine which may be the same as or different to the gaming machine of FIG. 2. The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, and an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted depending on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, such as, for example, providing input/output devices 106, 107, 108, 109, 110, 111 remotely from the game controller 101.

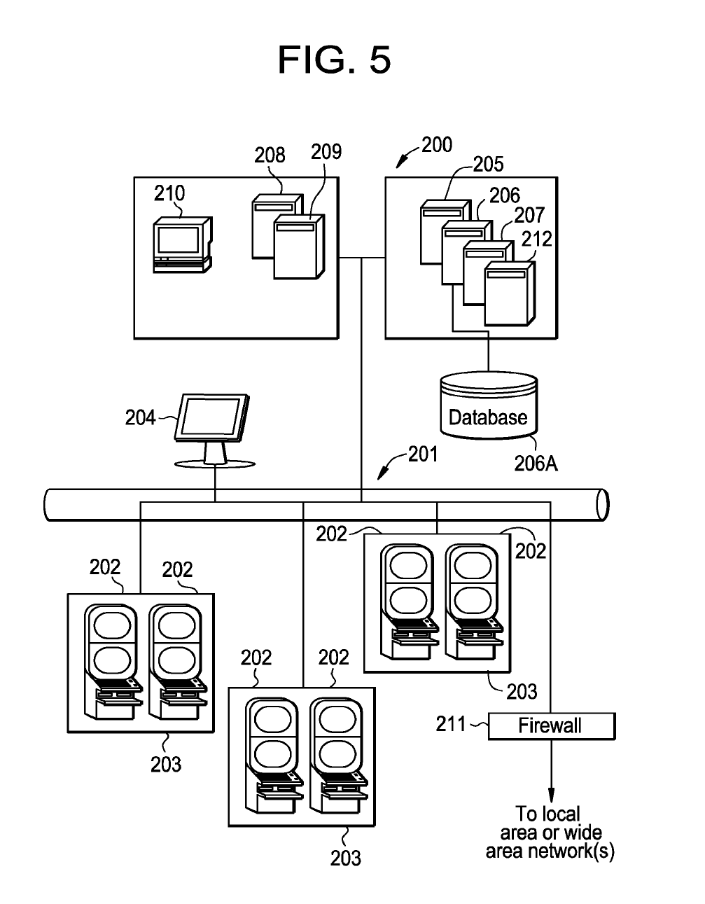

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10, 100 shown in FIGS. 2 and 3, or may have simplified functionality depending on the requirements for implementing game play. While banks 203 of two gaming machines are illustrated in FIG. 5, banks of one, three or more gaming machines are also envisioned.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example, promotional or informational material.

In a thick client embodiment, game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming machines 202 in a database 206A. Typically, if the gaming system enables players to participate in a Jackpot game, a Jackpot server 207 will be provided to carry out the accounting in respect of the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games based on the terminals.

Persons skilled in the art will also appreciate that the method of the embodiment could be embodied in program code. The program code could be supplied in a number of ways, for example on a computer readable medium, such as a disc or a memory (for example, that could replace part of memory 103) or as a data signal (for example, by downloading it from a server).

Some examples provide a spinning reel type game. Spinning reel type games typically allow a player to select how many pay lines of a plurality of pay lines they will play in each game—i.e. a minimum of one pay line up to the maximum number of pay lines allowed by the game. Persons, skilled in the art, will appreciate that in other examples, the player may select a number of reels to play. In most games, each pay line is formed by a set of symbol positions consisting of one symbol position from each reel. That is, a symbol position within the display which corresponds to a reel is assigned to a selected pay line. The symbol positions that constitute each of the pay lines are usually advertised to the player by markings on the display or diagrams showing the symbol positions that correspond to each offered pay line. Some of the pay lines will be horizontal or diagonal lines but others may be other combinations of symbols. Typically, the pay lines will be constituted by symbol positions in the visible window. A game outcome is determined based on the symbols on each wagered upon, e.g. bought, pay line and a prize table that specifies awards. Many modern games have five reels and three symbols of each reel are displayed when the reels stop defining a 3×5 matrix of displayed symbols. It should be understood that based upon the layout of the game reels “symbols” can include graphic representations such as cherries, 7 s or other graphic designs or may include “blanks” which are the absence of graphical designs on the reel. The number of reels and a number of symbols or reel stops on each reel may vary (e.g., three reels, four reels, six reels, four symbols per reel, five symbols per reel, etc.) defining different matrices.

In some implementations, the game controllers of such gaming machines select symbols by employing a stop determining function that randomly determines the stop position for each reel. For example, if there are five reels, each having twenty-two symbols, the stop determining function might determine that the stop positions are positions: 3, 13, 7, 9 and 17 for reels one through five. The spinning of the reels is then controlled so that each symbol designated by the stop position comes to a stop in the same row, typically a predetermined row in a “window” visible to the player on the display that corresponds to a player playing a single win line—e.g. the middle horizontal row. The other symbols that are visible in the display will be adjacent symbols in the symbol sequence—e.g. if the determined stop position is 3, then the symbols allocated to positions 2 and 4 (above and below the stop position 3) will also be visible if three symbols of each reel are displayed.

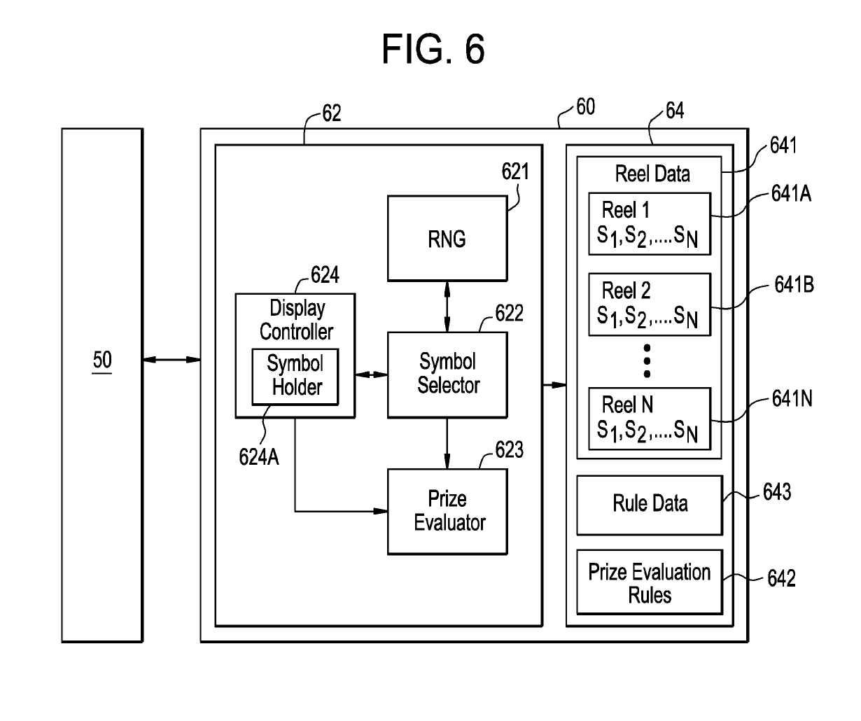

The game controller 60 of the embodiment is shown in more detail in FIG. 6. It will be apparent that the processor 62 implements a number of modules, for example random number generator module 621 by executing software routines. Persons skilled in the art will appreciate that not all modules need be implemented by processor 62. For example, the random number generator module 621 could be implemented by a separate circuit or by a random number generator server.

Referring to FIG. 6, in the embodiment, the symbol selector 622 is arranged to select a stop position for each reel independently of the symbol order S₁ to S_{N} specified in the reel data of each reel, reel 1 to reel N 641a, 641b, 641n. For example, each reel defines a physical reel strip (for electromechanical reels) having symbols laid out, in order, S₁ to S_{N}, The symbol selector 622 sends data which indicates the order in which the symbols of each reel were selected to the display controller 624. The display controller 624 controls display of spinning and stopping of the symbols of each reel. Accordingly, it includes a symbol holder function 624a which is arranged to control the display 54 for spinning and stopping of the symbols.

One example implementation includes five reels and three display positions for each reel as indicated by a 3×5 matrix of display positions. Accordingly, in an example where a reel contains symbols from S₁ to S₃₀, i.e. S₁ is the first symbol position, S₃₀ is the last and any other symbol in between such as S₁₀ represents the 10^{th} position in that reel strip. This reel is to spin within a reel column size displaying three symbols, one for each row.

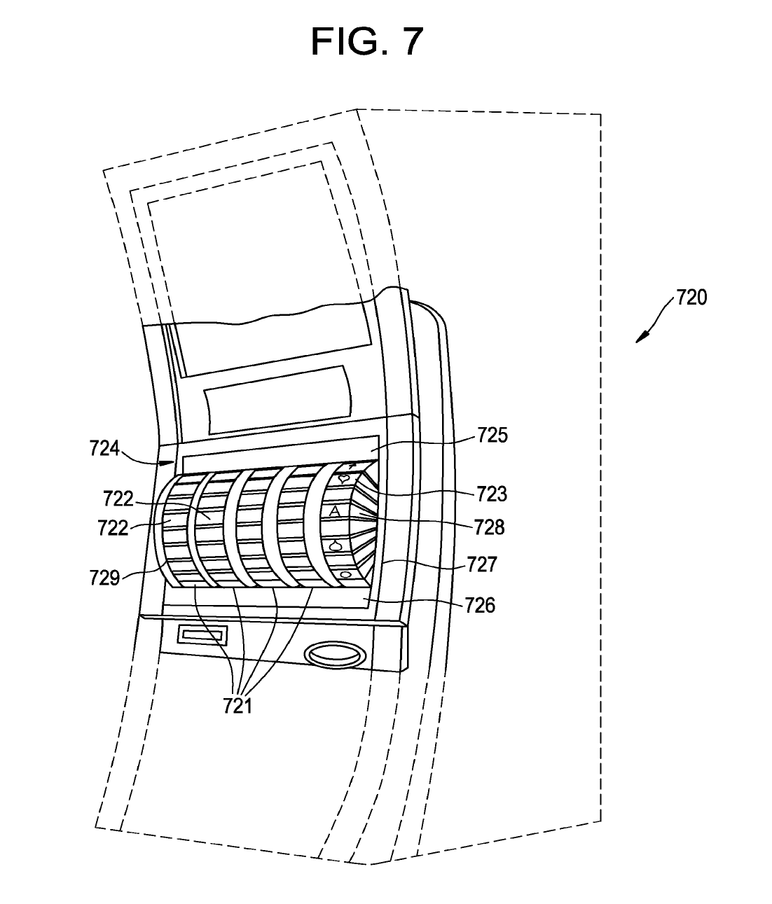

With reference to the embodiment shown in FIG. 7, the gaming machine 720 includes a set of five rotating reels 721 each having an outer peripheral wall 722 in the form of a strip on which images 723 are displayed. The images 723 may be printed symbols and/or animations. Either separately or in combination with printed or projected images, it is also possible for the outer wall 722 to include a video screen, or windows in which one or more video screens are in registration when the reels 721 are located in a stop position. The video screens can be used to display desired images as determined by a computer processor.

The gaming machine also includes a structural assembly 724 in the form of a front face including upper and lower panels 725, 726 located above and below the rotating reels 721 and side panels 727 located to the left and right sides of the rotating reels 721. As can be seen in FIG. 7, each of the five rotating reels 721 protrude beyond the panels 725 to 727 defining the front face of the gaming machine 720 and are mounted co-axially and have equal diameters. Although not shown in the figures, the outer walls 722 of the reels 721 can also include light sources including multi-colored light emitting diodes. Operation of the light sources can be controlled so as to project light in any sequence including sequences in association with spinning of the reels being started, stopped, during continuous spinning of the reels and on allocation of a payout being determined

To operate a gaming system, a provision is made for a player to enter a wager (money wager, wager of accumulated credits, etc.) and select symbol arrangements (pay lines or reels) upon which to wager and for prompting the gaming system to generate and display an outcome at a content display. If the outcome on any wagered upon arrangement is a winning outcome, the player is awarded credits, coins, tokens, vouchers, etc. If the outcome is a losing outcome the player receives no award. A winning outcome may be embodied as one, two or more symbols in the display (i.e. scatter awards) or may be embodied as predetermined combinations of symbols appearing in a wagered upon, e.g. bought up, symbol arrangement such as on an enabled (wagered upon) pay line.

The outcome may be determined, for example, by the combination of symbols which appear in the display matrix. Each of the displayed five spinning reels displays a plurality of symbols, and when stopped presents one or more symbols in the display. The symbols displayed may be associated with pay lines and/or may represent “scatter” wins (a predetermined number of symbols displayed anywhere in the game display), for example. Five symbols may appear along each horizontal “line” or row of the display. For example, the middle row may be the row wagered upon and upon which the outcome is determined The top row and the bottom row also have symbols and form two other pay line combinations of five symbols, which may be used to determine wins. Thus, a three-by-five matrix defining an array symbols appears as the content display.

Traditionally, pay lines are established for horizontal rows in the display matrix. However, modern games with up to fifty pay lines have been disclosed in U.S. Pat. No. 5,580,053 issued Dec. 3, 1996, to Crouch.

Game symbols are selected and displayed from a predetermined universe of symbols as set by the game designer. These symbols can be symbols which are common to numerous games as well as symbols which are unique to the individual game and reflect the overall theme of the game. As such, the symbols can have various shapes and colors or combinations of colors. For example, a symbol may be a brown horse with a red saddle, a bald eagle having the colors of white and grey, a human figure having flesh tones and blue clothing and so forth. Thus each symbol has a shape and a color (or multi-color) characteristic. In the display of a game outcome (or partial outcome) with a 5×3 matrix, there would be a display of fifteen symbols, some of which may appear only once in the display and some which may appear multiple times in the display.

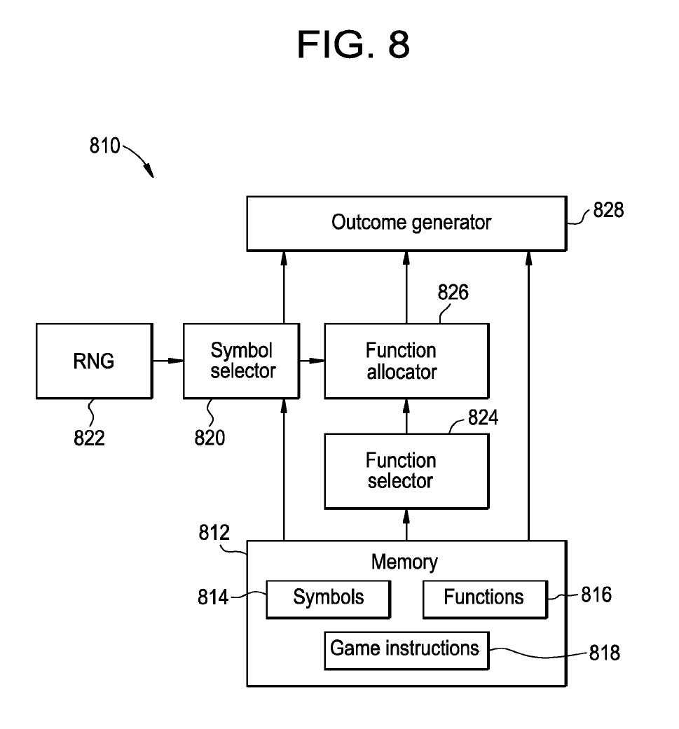

FIG. 8 shows a logical representation of a gaming system 810 arranged to implement a probabilistic game of the type wherein several symbols from a set of symbols are randomly displayed and a game outcome is determined on the basis of the displayed symbols. With some such probabilistic games, the set of symbols include standard symbols at least one of which is a function symbol, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display in the same line, scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

The gaming system 810 operates such that one or more function symbols can effectively be added during a game so as to modify the probability of occurrence of a win outcome and thereby enhance player interest in playing the game. This is achieved by selecting one or more symbols to acquire a new function and determining game outcomes based on displayed symbols and the new function. The function acquired by a symbol may be in place of or in addition to any function already associated with the symbol.

Referring to FIG. 8, the gaming system 810 comprises a memory 812 arranged to store symbol data 814 indicative of reel stops and symbols for subsequent display to a player and/or use in controlling the stop position of a motor driving a mechanical reel, as well as function data 816 indicative of one or more functions allocatable to the symbols and game instruction data 818 indicative of game instructions usable by the gaming machine 810 to control operation of the game.

The gaming system 810 also includes a symbol selector 820 which is arranged to select a stopping position for one or more reels in an electromechanical stepper reel gaming machine. In this example, the selection carried out by the symbol selector 820 is made using a random number generator 822.

It will be appreciated that the random number generator 822 can be of a type which is arranged to generate pseudo random numbers based on a seed number, and that in this specification the term “random” will be understood accordingly to mean truly random or pseudo random.

The gaming system 810 also comprises a function selector 824 arranged to select one or more functions for allocation to one or more symbols selected during the special game circumstances, and a function allocator 826 arranged to allocate the or each function selected by the function selector 824 to one or more symbols selected during the special game circumstances. The function selector 824 can be arranged to randomly select a function or to select a function on the basis of a predefined rule.

The gaming system 810 also comprises an outcome generator 828 which in accordance with the game instructions 818 determines game outcomes based on the symbols selected for display to a player by the symbol selector 820, and on the basis of the function(s) allocated to one or more selected symbols, if any.

In the examples described below, the symbol selector 820, the function selector 824, the function allocator 826, and the outcome generator 828 are at least partly implemented using a processor or microprocessor, although it will be understood that other implementations are envisioned.

The gaming system 810 can take a number of different forms, as described above.

Persons skilled in the art will appreciate that in some examples the player may operate a touch screen and/or buttons 107 (see, e.g., FIG. 3) to facilitate game play, for example.

In certain examples, mechanical reel slot machines are limited in that the physical reel strips have a certain number of symbol stops on each reel, such as twenty to twenty-two reel stops. One game design limitation of a physical reel strip is that combinations of multiple simultaneous pays can only have a few permutations compared to long virtual video strips with many more symbol positions available. By allowing more symbols to be visible on an electromechanical gaming machine and therefore available for play on such machines, more pays on different lines can occur, thus increasing the potential volatility of the game, for example.

Slot machines can utilize nine inch diameter reels with twenty-two (22) stops on each reel. With twenty-two reel stops, each symbol is approximately 360°/22=16.4° tall. However, motors found in electromechanical stepper machines are 400 step rather than 360 step such that most symbols are 18 steps×0.9°=16.2° per symbol with a few symbols at 20 steps=18.0° tall.

Concentrating on the front three symbols for display on an electromechanical reel, a maximum angle of 16.2°×3=48.6° is provided. With four symbols displayed, a maximum angle would be 64.8° (16.2°×4). Assuming that the middle symbol is centered on the reel in the display window, the top of the upper symbol on a three-symbol reel would be 24.3° above the center plane. With the middle two symbols centered, the top of the upper symbol on a four-symbol reel would be 32.4°, which is only 8.1° higher. Additionally, the center of the upper symbol, which is where the player's focus would be, is only about 4° higher.

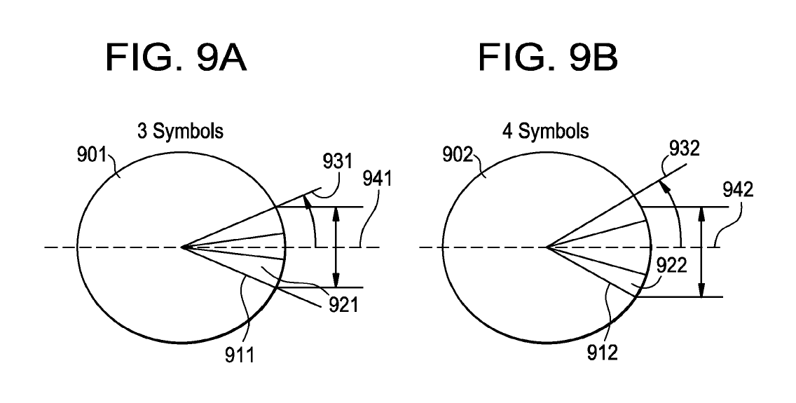

Turning to the front view visible to the player, as illustrated in FIG. 9A, a viewing or display window 911 in a reel 901 accommodating three symbols 921 high should have a dimension 941 of at least 3.38″ tall based on a viewing angle 931 per symbol of 24.3°. As illustrated, for example, in FIG. 9B, a four-symbol 922 high display window 912 in a reel 902 should have a dimension 942 of at least 4.07″ tall based on a per symbol viewing angle 932 of 32.4°. Allowing for one large (20 step) symbol, the window size would increase to 4.13″. Therefore, in some examples, a display window of approximately 4.6″ is provided to view symbols on reels of an electromechanical stepper gaming machine.

In some examples, backlighting is provided in addition to configuring a particular angle and height for reel position viewing. In some examples, such as with multi-line games, individual lighting is provided behind each symbol space. For example, a machine in which three symbols are made viewable per reel can have three lights behind each reel, one for each displayed symbol on the reel. By adding a fourth or more additional viewable/playable symbols, additional lights (e.g., a total of four or more) can be added corresponding to each additional symbol to allow those additional symbols to be backlight if applicable. Alternatively or in addition, lighting can be provided in an overlay formed as part of the display window over the reels and/or along the edges of the display area around the reels, for example. Pay line and/or pay pattern shapes, winning combinations, special effects, etc., can be shown via front, back, and/or integrating lighting, display, and/or other effect in conjunction with the symbol reels and display window for player viewing and entertainment.

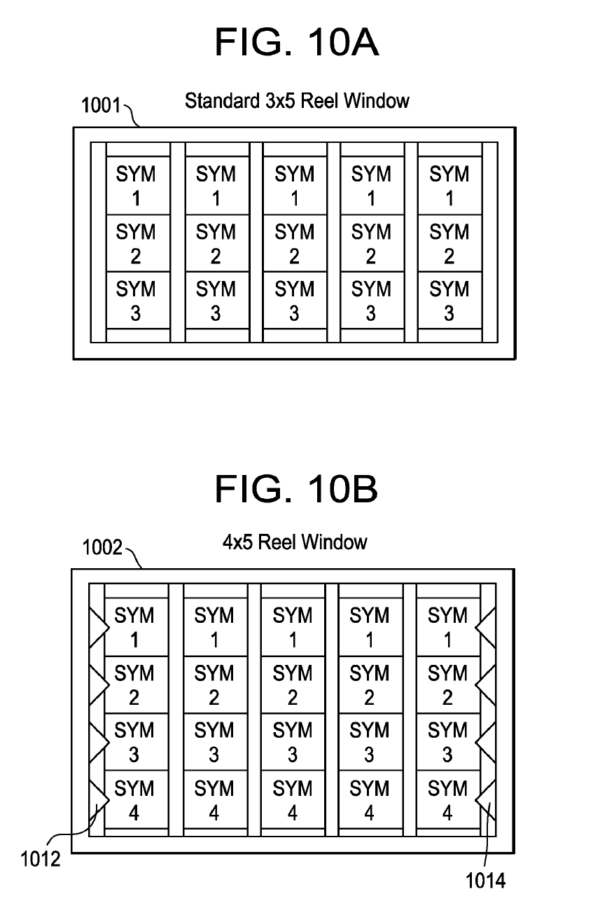

As shown in FIGS. 10A-10B, front views of a gaming machine showing a 3×5 reel window implementation 1001 (FIG. 10A) and a 4×5 reel window design 1002 (FIG. 10B) are provided. In some examples, in order to make the field of symbols clear to the player through the reel window 1002, indicators 1012, 1014 are added to the reel glass, highlighting the ends of the 4 rows.

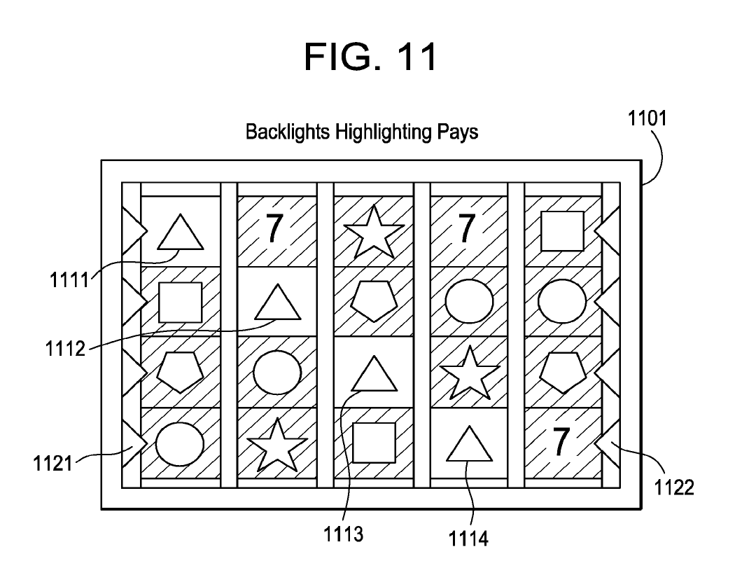

As illustrated, for example, in FIG. 11, another implementation to highlight the 4×5 reel and symbol display and provide indications of eligible symbol positions to players, so that players do not simply think that the gaming machine has badly aligned reels, is to use backlighting behind each symbol space. In this example, triangle symbols 1111-1114 are being back lit in the display window 1101 to show the player that all four of the display symbols 1111-1114 were involved in their winning combination and resulting pay. Indicators 1121-1122 can also be provided along the sides of the reel display window 1101 to highlight the ends of the four rows in play.

In some examples, four symbols can be made viewable to and usable by a player using the same size reel as a machine having three symbols on reel viewable and usable by a player. A larger (e.g., higher) window and different associated angle are used to allow four or more symbols on a reel to be put in play for gaming outcomes and viewed by the player. The reel viewing window dimensions can be adjusted depending upon whether the gaming machine is designed for a person to play the game while standing and/or while sitting, for example.

Other variations would be apparent to persons skilled in the art after reading this description and should be considered as falling within the scope of the invention described herein. In particular, further examples and/or embodiments can be formed from the features described above.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Further aspects of the method will be apparent from the above description of the gaming system. Persons skilled in the art will also appreciate that the method could be embodied in program code. The program code could be supplied in a number of ways, for example on a computer readable medium, such as a disc or a memory (for example, that could replace part of memory 103) or as a data signal (for example, by downloading it from a server).

It is to be understood that, if any prior art publication is referred to herein, such reference does not constitute an admission that the publication forms a part of the common general knowledge in the art, in the United States, Australia, or any other country.

Certain examples contemplate methods, systems and computer program products on any machine-readable media to implement functionality described above. Certain examples may be implemented using an existing computer processor, or by a special purpose computer processor incorporated for this or another purpose or by a hardwired and/or firmware system, for example.

One or more of the components of the systems and/or blocks of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method blocks and/or perform the blocks in a different order than the order listed. For example, some blocks may not be performed in certain embodiments of the present invention. As a further example, certain blocks may be performed in a different temporal order, including simultaneously, than listed above.

Certain examples include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples can be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples can also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A gaming machine comprising:
a reel comprising a plurality of symbol positions located around a circumference of said reel, each symbol position having a symbol disposed therein and occupying a defined viewing angle, wherein the symbols disposed in the respective symbol positions collectively form a set of symbols, the set of symbols including a plurality of normal symbols and function symbols;
a motor to drive said reel to spin in a gaming machine housing;
a controller to control said motor to stop and start to drive said reel and to selectively modify a probability of occurrence of a win outcome during a game by replacing one of the normal symbols on the reel with a function symbol; and
a viewing window to provide visual access to said reel through said viewing window, said viewing window configured to allow a user to view at least four symbol positions on said reel through said viewing window so that at least four symbol positions on said reel are active and available for game play.

2. A gaming machine as recited in claim 1, wherein said defined viewing angle comprises 16.2°.

3. A gaming machine as recited in claim 1, wherein said defined viewing angle comprises approximately 16°.

4. A gaming machine as recited in claim 1, wherein said defined viewing angle comprises between 16.2° and 16.4°.

5. A gaming machine as recited in claim 1, wherein said defined viewing angle comprises between 16° and 18°.

6. A gaming machine as recited in claim 1, wherein said motor comprises a three hundred sixty step motor.

7. A gaming machine as recited in claim 1, wherein said motor comprises a four hundred step motor.

8. A gaming machine as recited in claim 7, wherein said defined viewing angle comprises eighteen steps.

9. A gaming machine as recited in claim 8, wherein, for at least one of said symbol positions, said defined viewing angle comprises twenty steps.

10. A gaming machine as recited in claim 1, wherein a top of an upper symbol of the at least four symbol positions viewable on said reel is positioned at approximately 32.4° above a center plane of said viewing window.

11. A gaming machine as recited in claim 1, wherein said viewing window is approximately 4.6 inches high.

12. A gaming machine as recited in claim 1, wherein said viewing window is approximately 4.07 inches high.

13. A gaming machine as recited in claim 12, wherein said defined viewing angle per symbol position is 32.4°.

14. A gaming machine as recited in claim 1, wherein said viewing window is between 4.07 inches and 4.13 inches high.

15. A gaming machine as recited in claim 1, wherein said reel comprises backlighting for said plurality of symbol positions active and available for game play via said viewing window.

16. A gaming machine as recited in claim 1, further comprising a display overlay to display multimedia content over said reel.

17. A gaming machine as recited in claim 1, further comprising a plurality of indicators to indicate a location of each of said plurality of symbol positions active and available for game play via said viewing window.

18. An article of manufacture to be used in a slot machine game, said article of manufacture comprising:
a reel comprising a plurality of symbol positions located around a circumference of said reel, each symbol position having a symbol disposed therein and occupying a defined viewing angle, wherein the symbols disposed in the respective symbol positions collectively form a set of symbols, the set of symbols including a plurality of normal symbols and function symbols, a probability of occurrence of a win outcome during a game selectively modifiable by replacing one of the normal symbols on the reel with a function symbol; and
a viewing window to provide visual access to said reel through said viewing window, said viewing window configured to allow a user to view at least four symbol positions on said reel through said viewing window so that at least four symbol positions on said reel are active and available for game play.

19. An article of manufacture as recited in claim 18, wherein said defined viewing angle comprises approximately 16°.

20. An article of manufacture as recited in claim 18, wherein said defined viewing angle comprises between 16.2° and 16.4°.

21. An article of manufacture as recited in claim 18, wherein a top of an upper symbol of the at least four symbol positions viewable on said reel is positioned at approximately 32.4° above a center plane of said viewing window.

22. An article of manufacture as recited in claim 18, wherein said viewing window is between 4.07 inches and 4.13 inches high.

23. An article of manufacture as recited in claim 18, wherein said reel comprises backlighting for said plurality of symbol positions active and available for game play via said viewing window.

24. An article of manufacture as recited in claim 18, further comprising a display overlay to display multimedia content over said reel in conjunction with said viewing window.

25. An article of manufacture as recited in claim 18, further comprising a plurality of indicators displayed in conjunction with said viewing window to indicate a location of each of said plurality of symbol positions active and available for game play via said viewing window.

26. A gaming apparatus comprising:
a plurality of reels, each of the plurality of reels comprising a plurality of symbol positions located around a circumference of said reel, each symbol position having a symbol disposed therein and occupying a defined viewing angle, wherein the symbols disposed in the respective symbol positions collectively form a set of symbols, the set of symbols including a plurality of normal symbols and function symbols;
a plurality of motors, each motor to drive one of said plurality of reels to spin in a gaming machine housing;
a controller to control said motors to stop and start to drive said reels and to selectively modify a probability of occurrence of a win outcome during a game by replacing one of the normal symbols on the reel with a function symbol; and
a viewing window to provide visual access to said plurality of reels through said viewing window, said viewing window configured to allow a user to view at least four symbol positions on each of said plurality of reels through said viewing window so that at least four symbol positions on each of said plurality of reels are active and available for game play.

27. A gaming apparatus as recited in claim 26, wherein said viewing window is approximately 4.07 inches high and wherein said defined viewing angle per symbol position is 32.4°.

28. A gaming apparatus as recited in claim 26, wherein said reel comprises backlighting for said plurality of symbol positions active and available for game play via said viewing window.

29. A gaming apparatus as recited in claim 26, further comprising a display overlay to display multimedia content over said reel.

30. A gaming apparatus as recited in claim 26, further comprising a plurality of indicators to indicate a location of each of said plurality of symbol positions active and available for game play via said viewing window.
